(19) United States
(12) Patent Application Publication
(10) Pub. No.: US 2014/0069932 A1
(43) Pub. Date: Mar. 13, 2014

(54) Frac Tanks

(71) Applicant: Tom W. Musso, Bath, NY (US)

(72) Inventor: Tom W. Musso, Bath, NY (US)

(21) Appl. No.: 13/611,595

(22) Filed: Sep. 12, 2012

(51) Int. Cl. B65D 88/06; B23P 17/04

(52) U.S. Cl. 220/565; 29/428

(57) ABSTRACT

A frac tank adapted for vehicular transport and field storage of a liquid, comprising two parallel, elongated, hollow, intersecting cylinder sections that are capped at the longitudinal ends. Each section has an arcuate wall defining a cross-section of greater than 180°, a major diameter, and a minor diameter at the ends of the arcuate wall, wherein the ends of the arcuate wall of each section are sealingly joined to form the tank wall. The joined ends of the arcuate walls form inwardly directed cusps along the length of the tank with the major diameters spaced apart on either side of the cusps.

### BACKGROUND

The present invention relates to so-called “frac tanks” which are used in connection with production in oil and gas wells. The tanks contain thousands of gallons of water or proppant, which is pumped under high pressure down the well bore to push open, i.e., fracture, the earth formation or to keep the formation open.

It is known to provide cylindrical frac tanks supported on an L-skids, which brace the tanks externally and enable the tanks to be transported to the field and repositioned upright on a well pad for production. The tanks generally have a capacity of about 400 barrels, requiring a diameter of 12 feet. This width of tank has caused difficulties during transport on truck bodies over public roads, requiring special permitting, administration, and thus additional cost.

### SUMMARY

The purpose of the present invention is to provide a cylinder-type frac tank that does not require extensive internal reinforcement, avoids the difficulties and costs associated with the transport of conventional over-width cylindrical frac tanks, and is at least as space efficient as cylindrical frac tanks when arrayed on a well pad or the like.

The frac tank of the present invention can be considered as having the shape of two intersecting parallel cylinders.

With this shape, tanks having a maximum width of only eight feet and a capacity of about 300 barrels can easily be transported on a conventional flatbed truck, without special permitting and administrative delays and costs. As an example of development, an array of twelve such tanks closely spaced on a well pad of given size, provides greater capacity than a closely spaced array of eight 400 barrel cylindrical tanks on the same size pad.

According to one aspect, the invention is disclosed as a frac tank adapted for vehicular transport and field storage of a liquid, comprising two elongated hollow sections, each section having an arcuate wall defining a cross-section of greater than 180°, a major diameter, and a minor diameter at the ends of the arcuate wall, wherein the ends of the arcuate wall of each section are sealingly joined. The joined ends of the arcuate walls form inwardly directed cusps along the length of the tank with the major diameters spaced apart on either side of the cusps.

In a more detailed aspect, the disclosure includes an optional L-frame skid having one leg joined to an exterior surface of the wall of one section and another leg joined to the bottom of the tank. The one leg of the frame is attached to a truck body for horizontally orientated transport of the tank to the field, and the tank with skid are removable from the truck body for upright positioning of the tank in the field while resting on the other leg of the frame.

The invention can take the form of a stand-alone tank, a tank unit in which the tank is in combination with a skid or similar support, or a plurality of tanks arrayed in the field.

Another aspect of the invention is a method of fabricating a frac tank having the shape of two hollow, intersecting parallel cylinder sections. The method comprises: fabricating a plurality of metal rings, each ring composed of two opposed segments, with one segment forming a portion of one cylinder section and the other segment forming a portion of the other cylinder section, each segment having an arcuate wall defining a cross section of greater than 180 deg.; sealingly joining the ends of the arcuate wall of each segment to produce a plurality of metal rings; joining the rings to form an elongated tank wall having open ends; and capping the open ends of the tank wall.

### BRIEF DESCRIPTION OF THE FIGURES

FIG. 1 is an oblique view taken from above a frac tank unit including tank and skid or frame;

FIG. 2 shows one segment of the tank, which is mateable with an identical segment, to form one ring of a plurality of rings that are joined together to form the tank;

FIG. 3 is an end view of a representative mid-region of the tank, showing how two segments are joined together to form a ring which resembles the intersection of two parallel cylinders;

FIG. 4 is an oblique view of a representative skid or frame;

FIG. 5 is an oblique view of the tank before the end caps have been secured;

FIG. 6 is an oblique view of one of two bottom caps for the tank;

FIG. 7 is an oblique view of the top cap of the tank;

FIG. 8 is a schematic, longitudinal view of the tank unit, showing the preferred shape and orientation of the end caps; and

FIG. 9 shows the footprints of twelve intersecting cylinder tanks, each having eight foot major diameters, superimposed on the footprints of eight conventional cylindrical tanks having twelve foot diameters.

### DETAILED DESCRIPTION

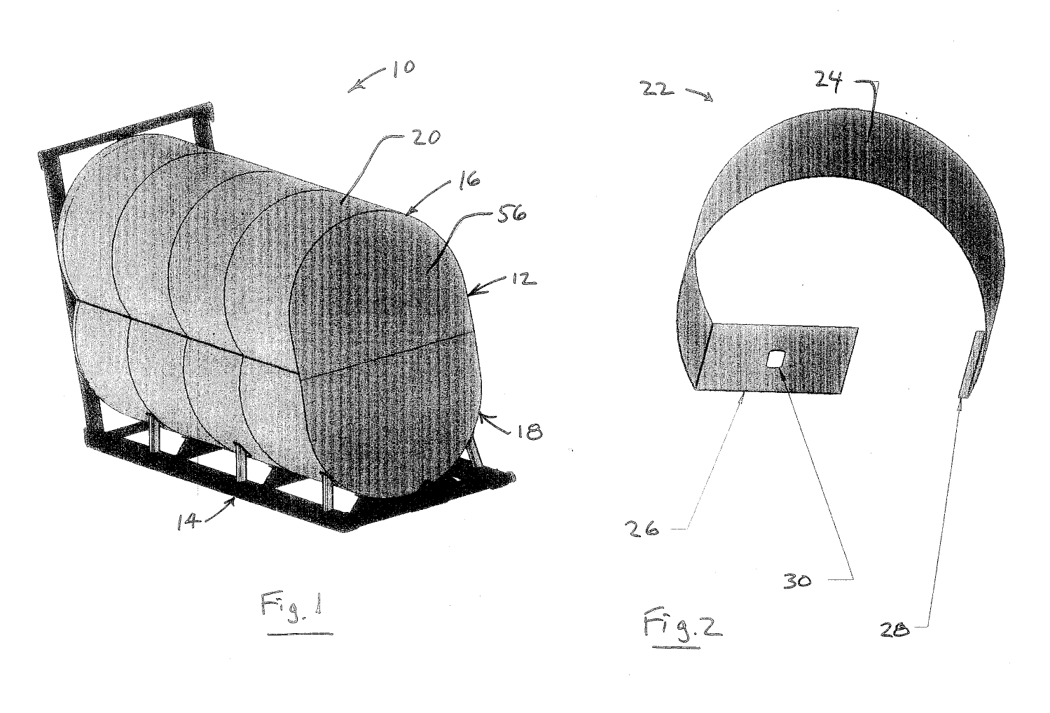

FIG. 1 shows a horizontally oriented tank unit 10 formed by the combination of tank or container 12 and skid or frame 14. The tank has a first or upper section 16 (resembling a portion of one hollow cylinder), and a second or lower section 18 (resembling a portion of another hollow cylinder). The tank 12 is formed by a plurality of connected rings 20. In the orientation of FIG. 1, the tank unit 10 can be loaded onto a transport vehicle such as a flatbed truck and delivered to a drilling or production site.

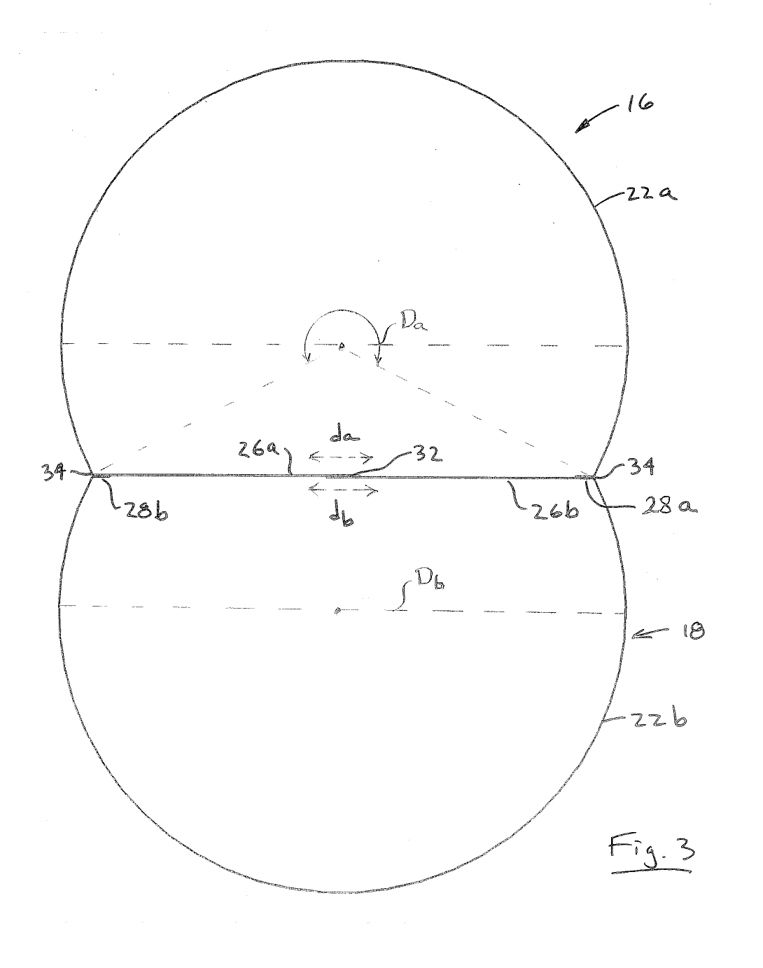

FIG. 2 shows the basic building block for each ring 20. Each ring is composed of two segments 22, each having a rolled portion 24 defining an arcuate wall which spans an arc of more than 180°. At one end of the arcuate wall, a relatively longer flange 26 extends substantially horizontally, and at the other end of the arcuate wall, a relatively shorter flange 28 also extends horizontally, leaving a gap between the two flanges. An opening 30 in the longer flange is provided to assure that the fluid in the tank can pass freely within the volume to maintain balanced weight distribution.

FIG. 3 shows how two of the segments 22a, 22b are joined together to form one ring among the plurality of rings that define the overall cross-section of the tank, which resembles the intersection of two parallel cylinders. Preferably, the upper and lower segments 22a, 22b are identically fabricated. They are joined such that the second segment 22b is reoriented by two, 180° rotations relative to the first segment 22a.

Thus, the longer flange 26a confronts the shorter flange 28b and the longer flange 26b confronts the shorter flange 28a. The confronting flanges are welded together along the full length of the cusp 34 (of the ring) formed at the intersection of the segments. The longer flanges 26a, 26b overlap at the center of the ring at 32 and are also welded together.

Upon viewing FIG. 3, it can be appreciated that the maximum width of the tank is at the major diameter Dₐ and (with identical segments) at the identical major diameter D_{b}. One can consider that the minor diameters dₐ and d_{b} are defined at the ends of the arcuate wall of each segment, and that is where the flanges form a support plate that connects the opposed cusps 34.

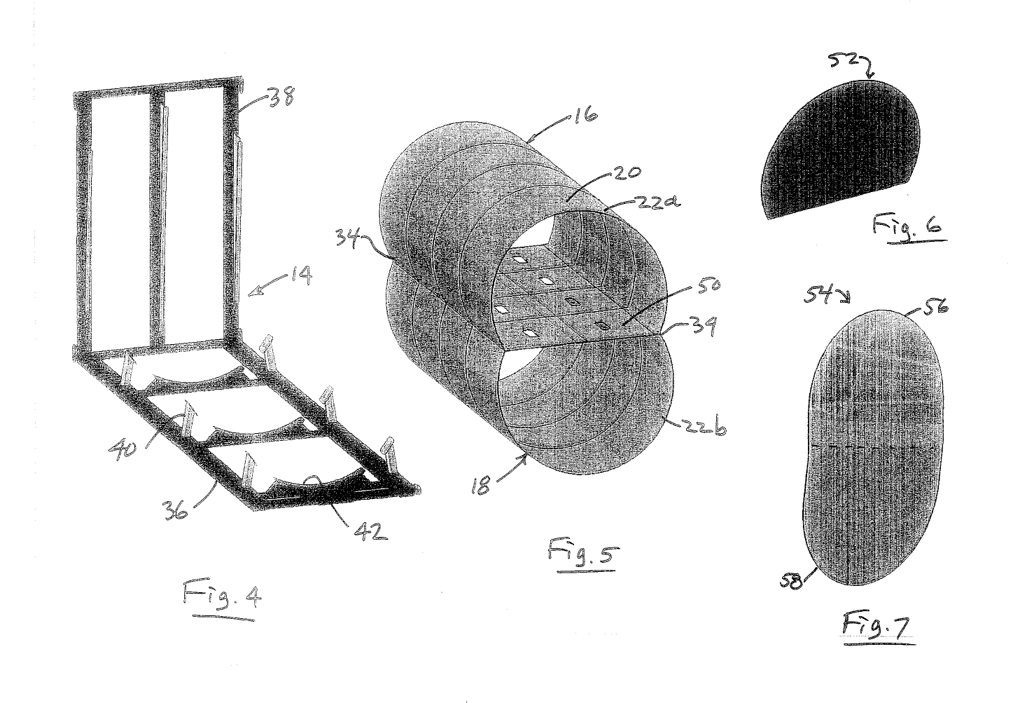

FIG. 4 shows the preferred form of the frame 14, comprising a horizontal, preferably longer leg 36 and a vertical, preferably shorter leg 38. Leg 36 has a plurality of straight support posts 40 and transverse, curved braces 42 that are supported by horizontal rails 44. The other leg 38 is likewise formed from a plurality of rails 46 which carry respective support bars 48.

FIG. 5 shows the tank during fabrication, wherein the cusps 34 can be seen more clearly as extending longitudinally at the intersection of the upper 16 and lower 18 sections of the tank. In the illustrated embodiment, four individually pre-assembled rings 20 are welded together, with each ring formed by the joining of segments 22a and 22b as described with respect to FIG. 3. The joining of the flanges within a ring and the optional joining of adjacent flanges from adjacent rings forms an overall unitary central support plate 50 extending between the cusps 34 of the tank, or a plurality of side by side supports plates associated with respective rings.

The plates 50 provide support against unbalanced force components that might arise at the inward (i.e., concave) cusps 34, in a direction parallel to the minor diameter. However, the convex arcuate shape of most of the ring surface 24 retains the strength of a cylindrical tank and needs no support or reinforcement against force components in a direction perpendicular to the minor diameter.

It should be understood that in the illustrated embodiment the upper and lower segments 16, 18 have the same size and shape, and thus the major diameters Dₐ and D_{b}, and minor diameters dₐ and d_{b} are the same, with the minor diameters being congruent and coextensive, and the major diameters spaced apart on either side of the minor diameters and cusps, but this is not absolutely necessary. Each segment 22a, 22b and thus each section 16, 18 is a portion of a cylinder in which the ends of the arcuate wall preferably span an included angle of at least about 200 deg., most preferably in the range of 220-250 deg.

The internal support for the tank can take a variety of forms, with at least one reinforcing member extending between spaced apart points on the wall of each section, preferably extending between the cusps.

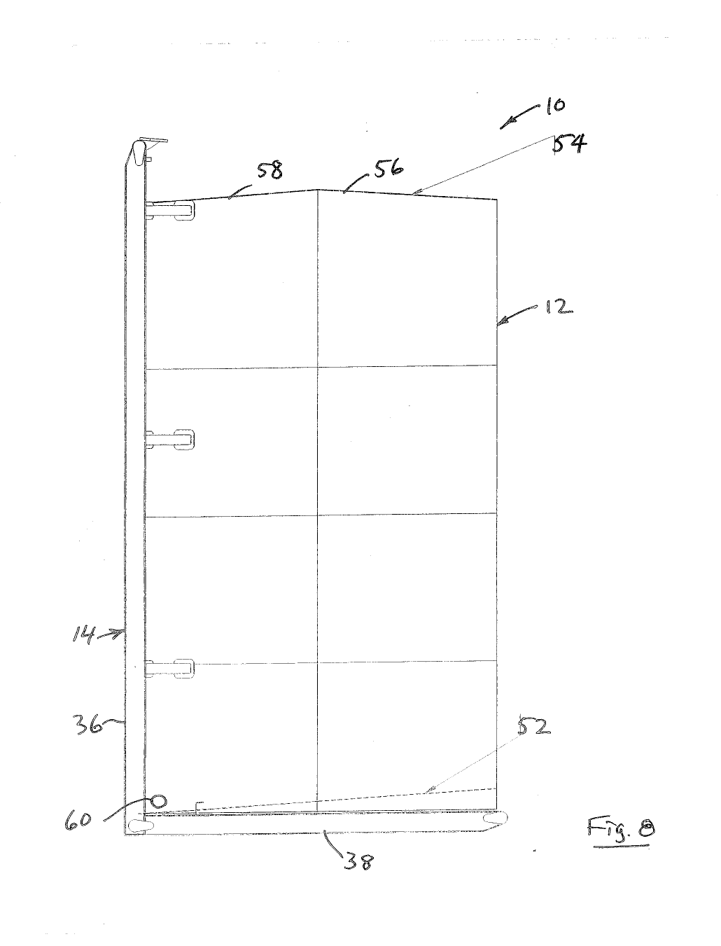

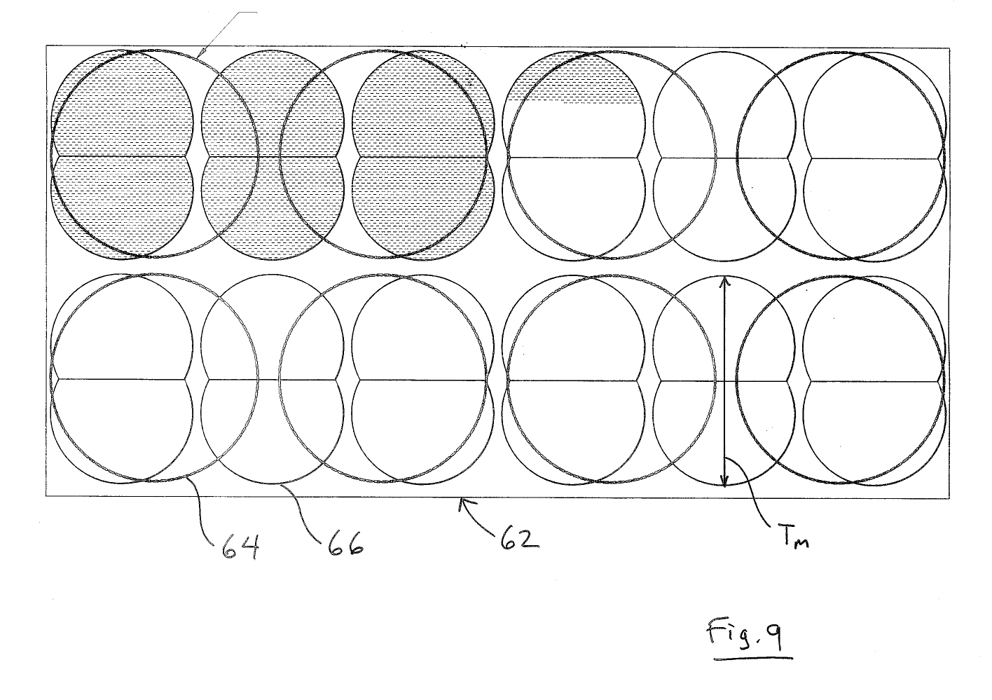

FIGS. 6, 7 and 8 show the preferred manner in which the ends of the tank 12 are closed, with FIG. 8 also depicting the tank unit 10 as would be deployed upright in the field for short term use. The bottom of the tank is closed at an angle by one or two connected bottom caps 52 and the closure 56 at the top of the tank has two angled portions 56, 58. The angle at the bottom assures that all liquid in the tank flows toward the valve 60, whereas the angle at the top helps shed rain or snow, etc.

FIG. 9 shows the perimeter of one possible frac tank well pad 62, which for convenience is selected as a 26 ft.×52 ft. rectangle, on which a plurality of frac tanks are situated without skids or frame, for long-term use. The pad accommodates eight conventional cylindrical tanks 64, each having a twelve foot diameter and a 400 barrel capacity, for a total volume of 3,200 barrels. The footprints of the eight conventional tanks are superimposed with the footprints of twelve tanks 66 according to FIG. 8 (without the skid), each having the same height but with a major diameter (maximum width of one section) of eight feet and a capacity of almost 300 barrels, for a total volume of 3,526 barrels. In this comparison, the maximum transverse dimension Tₘ of the inventive tank 66 is about twelve feet, the same as the diameters of the cylindrical tanks 64. In this preference but not limitation, the maximum transverse dimension Tₘ is 50% greater than the major diameters Dₐ and D_{b}.

It can thus be appreciated that the present invention provides a frac tank of smaller width that is more convenient to transport by truck relative to a conventional twelve foot diameter frac tank. When arrayed on a well pad of given area, similar or greater fluid capacity can also be achieved. Although to achieve this capacity advantage more tanks must be fabricated, the net cost is no greater. The total required surface areas of metal are similar, but the metal blanks can be thinner and more easily shaped and welded for the inventive tanks. Even if the inventive tanks did not provide any initial manufacturing cost advantage for the same total fluid volume required on a particular well pad or site, the combined advantages of routine tank transport without sacrificing fluid volume capacity on a given well pad, represent a significant improvement over conventional practice.

1. A frac tank, comprising:
two elongated hollow sections, each section having an imperforate arcuate wall defining a cross section of greater than 180 deg., a major diameter, and a minor diameter at the ends of the arcuate wall, wherein the ends of the arcuate wall of each section are sealingly joined; and
a cap at each longitudinal end of the tank.

2. The tank of claim 1, wherein when viewed longitudinally, the joined sections form intersecting parallel cylinders, with inwardly directed cusps formed at the minor diameters, along the length of the tank, and with the major diameters spaced apart on either side of the cusps.

3. The tank of claim 1, wherein each section is a portion of a cylinder in which the ends of the arcuate wall span an included angle in the range of about 200-250 deg.

4. The tank of claim 1, wherein the minor diameters of the sections are congruent and a rectangular, perforated plate extends along the minor diameters, thereby joining the cusps along the length of the tank.

5. The tank of claim 1, wherein at least one reinforcing member extends between the cusps.

6. The tank of claim 1, wherein at least one reinforcing member extends between spaced apart points on the wall of each section.

7. The tank of claim 1, wherein the tank has top and bottom ends, and an L frame skid has one, preferably longer leg joined to an exterior surface of the wall of one section and another, preferably shorter leg supporting the bottom of the tank.

8. The tank of claim 7, wherein the longer leg of the frame is attached to a truck body for transport to the field and removable from the truck body for upright positioning of the tank in the field while resting on the short leg of the frame.

9. The tank of claim 1, wherein
the major diameters of each section are substantially equal;
the minor diameters of each section are equal and congruent;
the maximum dimension across the tank through the centers of both sections is about 50% greater than the major diameters.

10. The tank of claim 9, wherein the major diameter is about eight feet.

11. The tank of claim 1, wherein the tank is composed of a plurality of rings welded together end to end, each ring composed of two opposed segments welded together, with one segment forming a portion of one section and the other segment forming a portion of the other section, each segment having an arcuate wall defining a cross section of greater than 180 deg., a major diameter, and a minor diameter at the ends of the arcuate wall, with the ends of the arcuate wall of each section sealingly joined.

12. The tank of claim 11, wherein each opposed segment has a flange extending inwardly from each end of the arcuate wall, and the flanges of one segment are welded to the flanges of the opposed segment.

13. The tank of claim 12, wherein the flanges as welded form a support plate that joins the ends of the arcuate walls of both segments.

14. The tank of claim 13, wherein the support plate of each ring is welded to the support plate of an adjacent ring.

15. A frac tank, comprising two parallel, elongated, hollow, intersecting cylinder sections that are capped at the longitudinal ends.

16. The tank of claim 15, wherein each cylinder section has an included angle in the range of about 200-250 deg.

17. The tank of claim 16, wherein the tank has a capacity of at least about 300 barrels, and is supported on a skid carried on a truck body.

18. The tank of claim 16, wherein the tank has a capacity of at least about 300 barrels, and a plurality of said tanks are arrayed in upright position on a well pad.

19. A method for fabricating a frac tank formed as two parallel, elongated, hollow, intersecting cylinder sections, comprising:
fabricating a plurality of metal rings, each ring composed of two opposed segments, with one segment forming a portion of one cylinder section and the other segment forming a portion of the other cylinder section, each segment having an arcuate wall defining a cross section of greater than 180 deg., a major diameter, and a minor diameter at the ends of the arcuate wall;
sealingly joining the ends of the arcuate wall of each to produce a plurality of metal rings;
joining the rings to form an elongated tank wall having open ends; and
capping the open ends of the tank wall.

20. The method of claim 19, wherein,
each opposed segment has a flange extending inwardly from each end of the arcuate wall;
the flanges of one segment are welded to the flanges of the opposed segment;
whereby the flanges as welded form a support plate that joins the ends of the arcuate walls of both segments.
